(19) United States
(12) Patent Application Publication
(10) Pub. No.: US 2011/0038049 A1
(43) Pub. Date: Feb. 17, 2011

(54) METHOD FOR DESIGNING A DIFFRACTION GRATING STRUCTURE AND A DIFFRACTION GRATING STRUCTURE

(75) Inventors: Tuomas Vallius, Tampere (FI); Juha Pietarinen, Pirkkala (FI); Pasi Laakkonen, Joensuu (FI)

Correspondence Address: FAY SHARPE LLP, 1228 Euclid Avenue, 5th Floor, The Halle Building, Cleveland, OH, 44115, US

(73) Assignee: NANOCOMP LTD, Joensuu (FI)

(21) Appl. No.: 12/528,346

(22) PCT Filed: Feb. 23, 2007
(86) PCT No.: PCT/FI2007/000044

§ 371 Date: Oct. 1, 2010

(51) Int. Cl. G02B 5/18; G06F 17/50

(52) U.S. Cl. 359/575; 359/569; 703/2

(57) ABSTRACT

According to the present invention, the method for designing a diffraction grating structure (1), the grating period (d) of the structure comprising at least two grating lines each consisting of a pair of adjacent pillars (2) and grooves (3), comprises the steps of—determining desired diffraction efficiencies η_{d} of the diffraction orders, and—dimensioning the pillars (2) and grooves (3) so that when calculating for each pillar, on the basis of the effective refractive index n_{eff} for the fundamental wave mode propagating along that pillar, the phase shift Φ experienced by light propagated through the grating structure, the differences in the calculated phase shifts between adjacent pillars corresponds to the phase profile Φᵣ required by the desired diffraction efficiencies.

### FIELD OF THE INVENTION

The present invention relates to the designing procedure of diffraction grating structures and diffraction grating structures, the focus being on the wavelength dependence of the grating performance.

### BACKGROUND OF THE INVENTION

Diffraction gratings are important components in micro-optics enabling effective light manipulation in a great variety of applications. Some typical applications include e.g. coupling light into and out from a waveguide or light guide, transforming a light beam into a wider beam or several sub-beams, and shaping an initially non-optimal geometry of a laser beam.

Despite the continuous development both in designing and manufacturing of effective grating structures, one serious problem still exists. In surface relief and volume gratings, the light propagating through the grating structure experiences a phase shift proportional to n_{g}h/λ, wherein n_{g} is the refractive index of the grating material, h is the grating structure thickness and λ is the wavelength. Thus, the phase of the field after the grating is strongly dependent on the incident wavelength. Because the phase plays a central role in the diffraction phenomenon, this results in a rapid change in the diffraction efficiency when altering the wavelength from the designed one.

In some particular cases, the wavelength dependence can be reduced to some extent by a grating material having a refractive index increasing as a function of wavelength. However, the general situation is that no universally applicable solution for controlling the wavelength response of a diffraction grating is known in the prior art.

### PURPOSE OF THE INVENTION

The purpose of the present invention is to provide a method for designing a diffraction grating structure having a controlled wavelength response over a large wavelength range. Another purpose is to provide such a grating structure.

### SUMMARY OF THE PRESENT INVENTION

The method for designing a diffraction grating structure and the diffraction grating structure of the present invention are characterized by what is presented in claims 1 and 6, respectively.

The method of the present invention is focused on diffraction grating structures, wherein the grating period comprises at least two grating lines each consisting of a pair of adjacent pillars and grooves. These kind of multi-line periods have basically been known for a couple of decades and one study showing the effectiveness and versatility of such grating structures was published e.g. by Saarinen et al in Applied Optics, vol. 34, pages 2401-2405 (1995).

According to the present invention, the method comprises the steps of:
determining a desired diffraction performance, i.e. desired diffraction efficiencies η_{d} of the diffraction orders, and
dimensioning the pillars and grooves so that when calculating for each pillar, on the basis of the effective refractive index n_{eff} for the fundamental wave mode propagating along that pillar, the phase shift Φ experienced by light propagated through the grating structure, the differences in the calculated phase shifts between adjacent pillars correspond to the phase profile Φᵣ required by the desired diffraction efficiencies.

Determining the desired diffraction efficiencies η_{d} comprises selecting in which diffraction orders and by which relative proportions the light should be diffracted. The simplest case naturally is to concentrate all diffracted light into the first diffraction order but the target can also be, just as one example, equal intensities into nine diffraction orders. Then, from the desired diffraction efficiencies, it is of standard routine for a person skilled in the art to calculate, through FFT (Fast Fourier Transform), the phase profile Φᵣ required to carry out that diffraction performance.

When light propagates in structures that consist of adjacent pillars near each other, light is confined to the regions with a higher refractive index. Therefore we can neglect the effect of the regions between the pillars and the response of the grating can be controlled by considering the light propagation within the pillars with a higher refractive index.

At the step of dimensioning the pillars and grooves, the core principle of the present invention is to treat each pillar of the grating period as a planar waveguide. Within waveguides light propagates in the form of waveguide modes, which have different lateral distributions. Each mode has also a different propagation speed that can be calculated by dividing the speed of light with the effective refractive index n_{eff} of the mode, i.e. c=c₀/n_{eff}. If the thickness of the waveguide is of the order of the wavelength, only the wave mode of the lowest order, called the fundamental wave mode, is of any importance thus defining the phase shift light undergoes when propagating along the pillar. Consequently, the effective refractive index of the lowest mode governs the behavior of light in each pillar and can be used to analyze the behavior of light in the structure. The present invention is based on the fact that the effective index of a waveguide depends on the waveguide dimensions. Thus, the effective refractive indices of the pillars and therefore the entire performance of the grating can be controlled by adjusting the dimensions of the pillars and grooves of the grating period.

Naturally, also the effective refractive index is wavelength dependent and so is the total phase shift light undergoes in the length of a pillar. However, the inventors have now found that by proper selection of the dimensions of the pillars and grooves and thus the effective refractive indices it is possible to control the phase differences between different pillars and so the wavelength response of the grating. This ability to control the wavelength response is a great step for the entire technical field of diffraction gratings.

Correspondence of the difference in the calculated phase shifts Φ between two adjacent pillars with the required phase profile curve Φᵣ means that said difference is substantially equal to a phase difference between two points of the required phase profile curve at locations substantially coinciding with the locations of said pillars.

In one preferred embodiment of the present invention, when determining the desired diffraction efficiencies η_{d} to be substantially constant in a wavelength range from λ₁ to λ₂, the pillars and grooves are dimensioned so as to produce the differences in the calculated phase shifts Φ between adjacent pillars substantially constant in that wavelength range. The calculated phase shift of one pillar of height h having effective index n_{eff} is Φ=n_{eff}h2π/λ. The phase difference between two pillars of equal heights is then ΔΦ=(Δn_{eff})h2π/λ. Thus, the phase shift ΔΦ can be set to be constant by choosing the effective indices so that their difference Δn_{eff} is proportional to wavelength λ. When seeking substantially constant diffraction efficiencies, the minimum value of the difference in the calculated phase shifts for any two adjacent pillars is preferably at least 80%, more preferably at least 90% of the maximum value. The substantially flat wavelength response achievable with this embodiment of the present invention is very advantageous in many applications.

In another preferred embodiment of the present invention, the desired diffraction efficiencies η_{d} are determined to have a non-constant wavelength response, and the pillars and grooves are dimensioned so as to produce said correspondence between the differences in the calculated phase shifts Φ of adjacent pillars and the phase profile Φᵣ required by the desired diffraction efficiencies at several wavelengths λᵢ. When the desired diffraction efficiencies η_{d} of the diffraction orders depend on the wavelength, there is a specific phase profile Φᵣ required by those diffraction efficiencies for each wavelength λᵢ, respectively. By said producing said correspondence at several wavelengths, the grating structure is made carry out the desired non-constant diffraction performance. The more wavelengths are treated, the more accurately the final performance of the realized grating follows the desired diffraction efficiencies. A very advantageous feature of this embodiment of the present invention is that principally any wavelength response of the diffraction performance can be achieved.

In one preferred embodiment, the non-constant wavelength response of the desired diffraction efficiencies η_{d} is determined so as to substantially compensate the spectrum of a light source in an optical system comprising the light source and the diffraction grating. For example, in systems comprising a thermal light source like a bulb, it can be advantageous to compensate the inherent Planck intensity distribution of the light source in order to provide illumination with a flat wavelength response of the intensity. On the other hand, e.g. in some illumination applications the desired spectrum after the diffraction grating could be daylight-like wavelength dependence of the intensity and the desired diffraction efficiencies should be then selected correspondingly.

It is important to note that the waveguide analogy explained above and the results of said calculations are not completely accurate in all cases. In fact, for example, the narrower the pillars are, the less exact are the assumptions made and further the results of the calculations. The diffraction performance could be calculated more exactly by means of the electromagnetic diffraction theory to obtain reliable results. However, using the electromagnetic theory, we cannot achieve results in a closed form and the grating structure profile cannot be solved directly from the required phase curve of the grating. To solve this problem, in one embodiment of the present invention, the method further comprises the step of parameter optimizing wherein the dimensions of the pillars and grooves calculated on the basis of the effective refractive indices n_{eff} are used as a starting point for the optimization procedure. For providing a starting point for the optimization, the waveguide analogy approach is, in most cases, a sufficiently accurate way to describe the structure required to fulfill the desired grating performance. At the final optimization step, also possible restrictions in the grating geometry set by manufacturing processes can be taken into account.

The diffraction grating structure of the present method comprises at least two grating lines each consisting of a pair of adjacent pillars and grooves. According to the present invention, the dimensions of the pillars and grooves are such that when calculating for each pillar, on the basis of the effective refractive index n_{eff} for the fundamental wave mode propagating along that pillar, the phase shift Φ experienced by light propagated through the grating structure, the differences in the calculated phase shifts between adjacent pillars correspond to the phase profile Φᵣ required by predetermined desired diffraction efficiencies η_{d} of the diffraction orders. In other words, the difference in the calculated phase shifts of two adjacent pillars is substantially the same as the phase difference between two points of the required phase profile, the points being selected at locations corresponding to the pillar locations. The principle of the effective index approach is explained above relating to the method of the present invention.

In one preferred embodiment of the present invention, the predetermined desired diffraction efficiencies η_{d} are substantially constant in a wavelength range from λ₁ to λ₂, and the dimensions of the pillars and grooves are correspondingly adjusted so as to produce the differences in the calculated phase shifts Φ between adjacent pillars substantially constant in that wavelength range. More precisely, the wavelength range preferably extends from λ₁ to at least λ₂=1.5λ₁, more preferably to at least λ₂=2λ₁. This broad wavelength bands having substantially flat diffraction efficiency have not been achievable with prior art solutions.

In another preferred embodiment, the predetermined desired diffraction efficiencies η_{d} have a non-constant wavelength response, and the dimensions of the pillars and grooves are such that they produce said correspondence between the calculated phase shifts Φ and the phase profile Φᵣ required by the desired diffraction efficiencies at several wavelengths λᵢ. For example, the non-constant wavelength response of the predetermined desired diffraction efficiencies η_{d} can substantially compensate the spectrum of a light source in an optical system comprising the light source and the diffraction grating. This way the wavelength response of the output of that kind of optical system can be set to be constant. This provides unparalleled advantages e.g. in many illumination applications.

Preferably, the grating period of the diffraction grating structure comprises at least two different groove depths. Groove depth in this document means the vertical distance from the top of a pillar to the bottom of an adjacent groove. As is known for a person skilled in the art, the overall efficiency of the grating can be enhanced when the degrees of freedom for the design phase are increased. The effectiveness of a grating structure comprising two grating lines and two groove depths is proved e.g. by Laakkonen et al in Journal of the Optical Society of America A, vol. 23, pages 3156-3161 (2006).

In addition to groove depths, the degrees of freedom can also be increased by increasing the number of grating lines in one period. Therefore, in one preferred embodiment, the grating period of the diffraction grating structure comprises at least three grating lines. Another advantage of this is that as the number of grating lines increases, the phase profile produced by discrete pillars naturally approaches to the continuous curve of the required phase profile Φᵣ.

Preferably, the grating structure is of slanted type. A slanted grating geometry has found useful and effective particularly in different coupling applications, e.g. in coupling light into and/or out from a waveguide or light guide.

To summarize the advantages of the present invention, the method and grating structure of the present invention first time provides a way to effectively control the wavelength dependence of a diffraction grating over a wide wavelength range. This provides great benefits in utilizing diffractive optics and also opens totally new fields of applications thereof.

### BRIEF DESCRIPTION OF THE DRAWINGS

The accompanying figures, which are included to provide a further understanding of the invention and constitute a part of this specification, illustrate embodiments of the invention and, together with the description, help to explain the principles of the invention.

FIG. 1 illustrates the designing procedure according to one embodiment of the present invention.

FIGS. 2 and 3 show grating structure examples according to the present invention.

FIGS. 4 to 10 represent simulated results of grating structures according to different embodiments of the present invention.

### DETAILED DESCRIPTION OF THE INVENTION

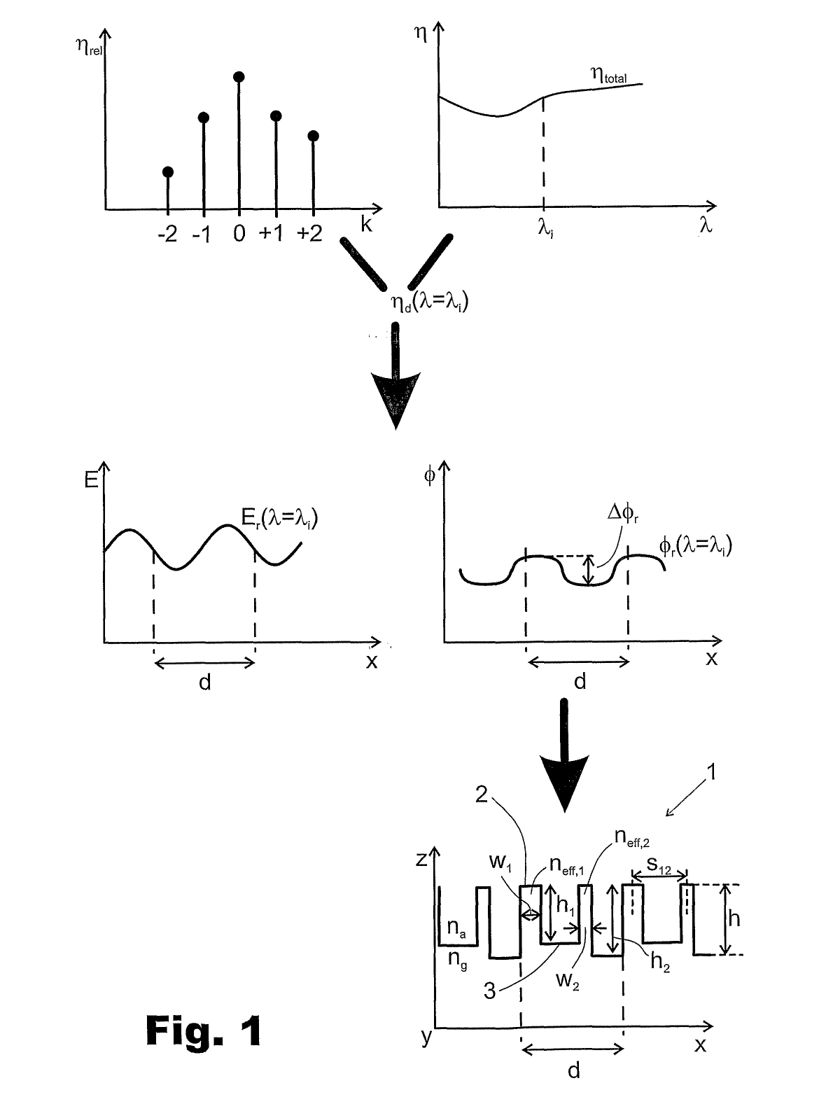

The designing process illustrated by graphs of FIG. 1 starts by determination of the desired diffraction efficiencies of different diffraction orders k and the wavelength dependence of the diffraction performance. Desired diffraction efficiencies can be determined as relative proportions ηᵣₑₗ of the total diffraction efficiency ηₜₒₜₐₗ i.e. the sum diffraction efficiencies of all diffraction orders excluding the zeroth one, as shown in FIG. 1, or by absolute efficiencies e.g. by means of square of transmission. In the procedure of FIG. 1, it is approximated that the mutual proportions of the diffraction orders other than the zeroth one remain constant and the wavelength response is treated as the wavelength response of the total diffraction efficiency ηₜₒₜₐₗ. Whatever is the way of determining the desired diffraction efficiencies, there is principally a specific set of desired diffraction efficiencies η_{d} of different diffraction orders for each wavelength λᵢ. Thus, one can then calculate from η_{d}, for each wavelength λᵢ, through Fourier Transform, the required profiles of electrical field Eᵣ and phase Φᵣ as a function of location x at the grating structure surface. Both of those profiles are periodic with a period of d.

The critical step in the process is converting the required phase profile into a grating structure. The lowermost graph of FIG. 1 shows, as a function of location x at the grating structure surface, a grating structure surface profile 1 having a two-line grating period with two pillars 2 and grooves 3, the pillars being located substantially at the maximum and minimum of the required phase profile curve Φᵣ. In the designing procedure, each pillar is treated as a waveguide having a thickness wᵢ in x-direction and being invariant both in the longitudinal direction of the pillar, i.e. in the z-direction, and in the direction of y-axis. For this kind of waveguide, one can calculate an effective refractive index n_{eff,i} of the lowest wave mode propagating along the pillar. The effective refractive index of each pillar depends naturally on the refractive index n_{g} of the grating material but also on the pillar width wᵢ as well as on the ambient refractive index nₐ. Each pillar produces the light propagating through the grating structure a calculated phase shift Φᵢ=hn_{eff,i}2π/λ, wherein h denotes the grating structure thickness. For the sake of simplicity, in this equation the effect of the possible difference between the height of the pillar at issue and the entire grating structure thickness is ignored. Strictly speaking, the phase shift below the actual pillar geometry is dependent on the refractive index n_{g} of the grating material instead of n_{eff,i} and, in fact, taking this into account, the phase produced by each of the pillars can be fine-tuned by adjusting each groove depth hᵢ separately. One parameter also affecting the overall performance of the grating structure is the spacing sᵢⱼ between the centre lines of adjacent pillars i and j.

The dimensions of the pillars and grooves and thus the effective indices of the pillars are now dimensioned so that the difference between the calculated phase shifts of the adjacent pillars are substantially equal to the phase difference ΔΦᵣ between the maximum and minimum of the required phase profile:

ΔΦᵢ=Φ₂−Φ₁=h(n_{eff,2}−n_{eff,1})2π/λΦᵣ.

In the case of more than two grating lines in a single grating period, one has to adjust correspondingly the difference in the phase shifts between each pair of adjacent pillars. Thus, e.g. with three grating lines, there are two pairs of adjacent pillars to be analyzed and compared to the required phase profile.

In the simplest case of constant wavelength response of the desired diffraction performance, the required phase profile Φᵣ is independent from wavelength. Then the procedure described above needs to be performed only once and one just needs to assure that the calculated phase difference ΔΦᵢ of adjacent pillars remains substantially constant over the wavelength range at issue.

The designing process is somewhat more complicated when non-constant wavelength dependence of the diffraction efficiency is desired. Then the comparison of the calculated phase shift difference between two pillars with the required phase profile needs to be performed at several wavelengths λᵢ and a geometry needs to be found which fulfils the requirement of phase difference correspondence described above at each of those wavelengths. Naturally, the more accurate implementation of the desired wavelength response of the diffraction efficiency is sought, the more wavelengths need to be examined.

After the procedure illustrated in FIG. 1, final tuning of the grating geometry design can then be performed by a subsequent step of parameter optimization using the dimensioned pillars and grooves as a starting point.

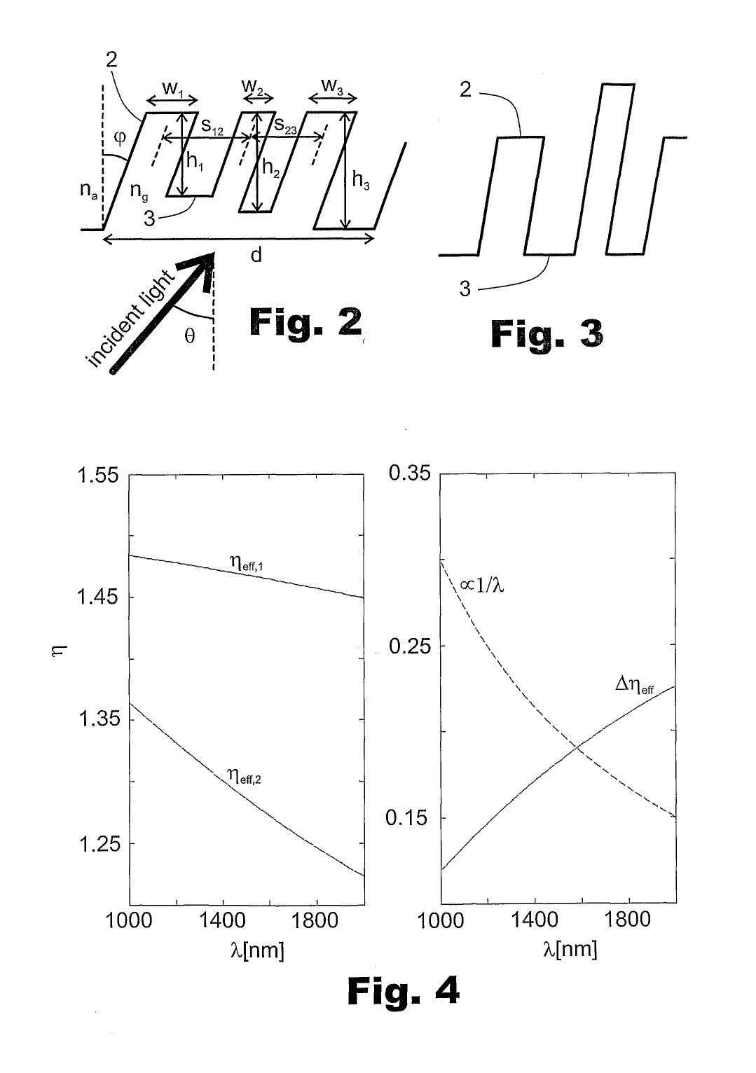

FIG. 2 shows one example of a bit more sophisticated grating structure in comparison to that of FIG. 1. The grating period consists of three pairs of pillars 2 and grooves 3. In addition to three grating lines instead of two, the grating structure profile shown in FIG. 2 differs from that of FIG. 1 also in that the grating is of slanted type. This means that the pillars and grooves are tilted with respect to the normal of the grating plane by an angle φ. Slanted grating geometry has been found to be very effective in many applications. In addition to the detailed dimensions of the structure, one key parameter relating to the designing process and operation of the grating is the incident angle θ of light interacting with the grating. In the illustration of FIG. 2, light comes to the grating structure from the side of the grating substrate. Naturally, the designed direction of incidence could also be from the opposite side.

In contrast to the grating structure surface profiles of FIGS. 1 and 2, the bottoms of the grooves 3 of the grating shown in FIG. 3 are on the same level but the tops of the pillars 2 are located at different heights. This kind of structure is particularly advantageous when gratings are manufactured by a replicating technique, i.e. by stamping the grating profile to a grating body material by a master tool having an inverted profile of the final grating structure. The master tool is easier to manufacture so as to have pillars of equal heights and variable groove depths than vice versa. The principles of effective indices and phase shifts are valid for this structure too and the structure parameters can be chosen according to the principles described above.

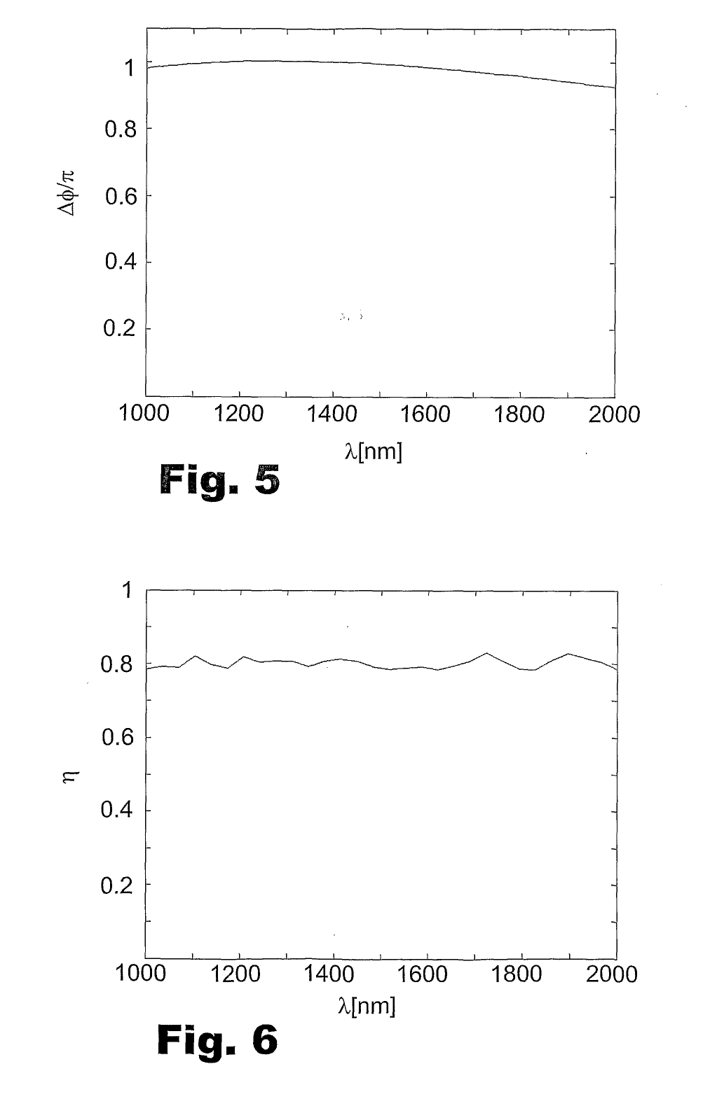

Several studies have been made in order to verify the performance of the present invention. For example, FIG. 4 shows effective indices for pillars in a two-line grating structure for TM polarization designed to produce high diffraction efficiency into the first diffraction order with substantially constant diffraction efficiency over a wavelength range from 1000 to 2000 nm. The incident angle of light was set to be perpendicular. The refractive index n_{g} of the grating material was set to 1.5 and that of the output material to nₐ=1.0. According to the required phase profile, the difference in the phase shifts between the two pillars was π, which yields maximum deflection of the incident light. As is shown in FIG. 4, effective indices of the lowest modes for both pillars n_{eff,1}, n_{eff,2} of the designed structure decrease as a function of wavelength. However, the pillars are dimensioned so that their difference Δn_{eff,i} increases at a rate which substantially compensates the decrease of term 1/λ in equation ΔΦ=hΔn_{eff}2π/λ. Thus, as shown in FIG. 5, the difference ΔΦ of the phase shifts of the pillars, which plays a major role in the characteristics of the grating, is substantially constant.

After a step of further parameter optimization, the structure originally having a calculated height of the grating structure h=4100 nm was defined by parameters: d=3252 nm, h₁=3153 nm, h₂=3802 nm, θ=0°, φ=5.4°, w₁=555 nm, w₂=1406 nm, and s₁₂=1556 nm. Simulated diffraction efficiency of the structure is depicted in FIG. 6. The efficiency is centered on 80% with a notably small variation, thus clearly outperforming the conventional diffraction gratings. Even though the wavelength doubles, the efficiency is not significantly altered. The design was made for TM-polarization but corresponding structures can be designed to TE-polarization too. (If the electric field has only the y-component, the state is called TE-polarization. If the magnetic field has only the y-component, the state is called TM-polarization.) This example also proves that slanted structures allow high efficiencies under normal incidence with wideband behavior.

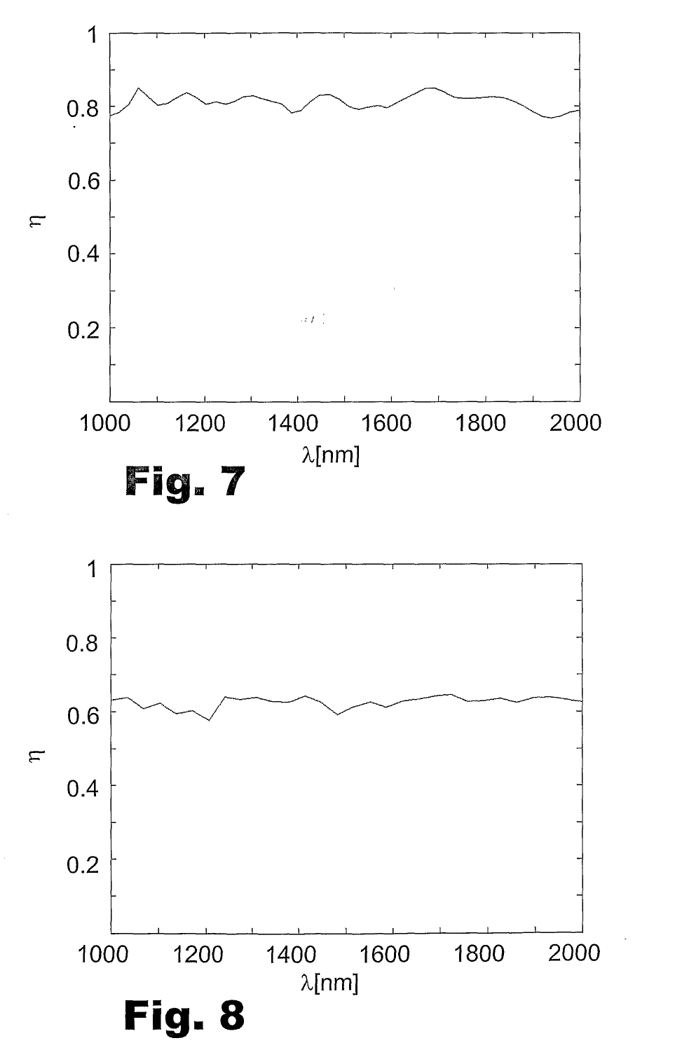

Another examined grating structure consisted of three pillars instead of two. Final parameter optimization yielded parameters: d=3656 nm, h₁=3441 nm, h₂=3859 nm, h₃=3863 nm, θ=−5°, φ=0°, w₁=134 nm, w₂=589 nm, w₃=1421 nm, s₁₂=1012 nm, and s₂₃=1695 nm. When more grating lines are present in a single grating period, larger periods can be used and thus smaller diffraction angles obtained. The simulated diffraction efficiency for this structure is shown in FIG. 7. Again, the behavior is nearly wavelength independent and the efficiency is high over the entire wavelength range from 1000 to 2000 nm.

The above examples were related to TM-polarization only. Gratings have been designed also for unpolarized light. One example of two-line grating period designed for unpolarized light was determined by parameters: d=3605 nm, h₁=3033 nm, h₂=3192 nm, θ=−6.3°, φ=0°, w₁=479 nm, w₂2=1265 nm, and s₁₂=1456 nm. The response of the grating is shown in FIG. 8. Now the efficiency is lower but still the curve does not depend remarkably on wavelength. The structure is not optimal for either polarization but works reasonably for both polarizations.

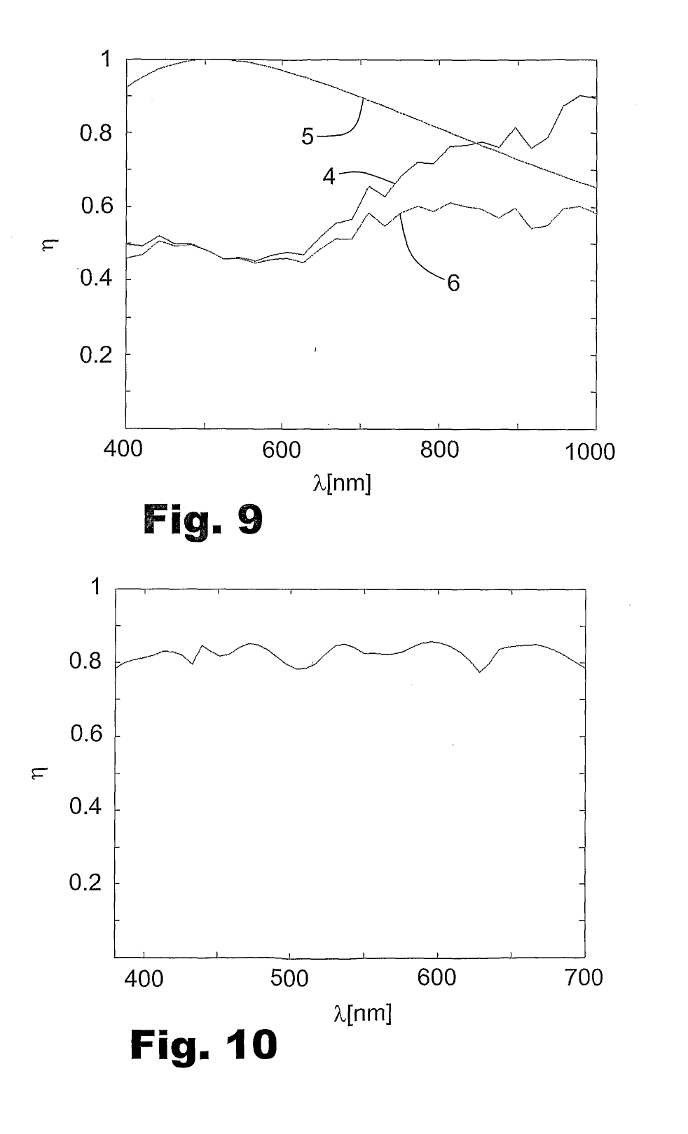

Besides a flat wavelength response, there are many applications where diffraction efficiency would be desired to have some particular wavelength response instead of just flat one. For example, compensating the inherent spectrum of a light source by the spectral response of a diffraction grating would provide advantages in many applications. One test structure highlighting the flexibility of the present invention was designed to cancel out the Planck intensity distribution constituting the basic spectral response of most thermal light sources. The optimized grating of a two-line grating period had the following parameters: d=1621 nm, h₁=2278 nm, h₂=2600 nm, θ=−9.5°, φ=0°, w₁=352 nm, w₂=790 nm, and s₁₂=648 nm. In this case the wavelength range was restricted to the visible part of the spectrum and near infrared, i.e. 400-1000 nm. The simulated diffraction efficiency 4 and the Planck curve 5 as well as their product 6 representing the total output are presented in FIG. 9. As can be seen in FIG. 9, the present invention makes it possible to have almost constant output trough the grating even though the input intensity contains significant variations.

Finally, FIG. 10 shows simulated efficiency curve for TM polarization and for visible light of a designed structure with a higher refractive index n=1.7. The structure had the following parameters: d=1058 nm, h₁=72 nm, h₂=843 nm, θ=−6.4°, φ=0°, w₁=186 nm, w₂=439 nm and s₁₂=483 nm. Now the minimum of the efficiency is 77.5% and the structure is much shallower because of the higher refractive index. The aspect ratio of the narrowest groove is now 5.3, which is within the fabrication limits.

As is obvious for a person skilled in the art, the basic idea of the present invention may be implemented in various ways. The invention and its embodiments are thus in no way limited to the examples described above but they may vary within the scope of the claims. Particularly it has to be understood that the wavelength response of the diffraction efficiency can be principally of any desired type. The invention is applicable for infrared, ultraviolet and visible region of the spectrum. Also the designed incident angle of light can vary significantly and can be controlled by the slanted angle.

1. A method for designing a diffraction grating structure (1), the grating period (d) of the structure comprising at least two grating lines each consisting of a pair of adjacent pillars (2) and grooves (3), characterized in that the method comprises the steps of
determining desired diffraction efficiencies η_{d} of the diffraction orders, and
dimensioning the pillars (2) and grooves (3) so that when calculating for each pillar, on the basis of the effective refractive index n_{eff} for the fundamental wave mode propagating along that pillar, the phase shift Φ experienced by light propagated through the grating structure, the differences in the calculated phase shifts between adjacent pillars correspond to the phase profile Φᵣ required by the desired diffraction efficiencies.

2. A method according to claim 1, characterized in that the desired diffraction efficiencies η_{d} are determined to be substantially constant in a wavelength range from λ₁ to λ₂, and the pillars (2) and grooves (3) are dimensioned so as to produce the differences in the calculated phase shifts Φ between adjacent pillars substantially constant in that wavelength range.

3. A method according to claim 1, characterized in that the desired diffraction efficiencies η_{d} are determined to have a non-constant wavelength response, and the pillars (2) and grooves (3) are dimensioned so as to produce said correspondence between the calculated phase shifts Φ and the phase profile Φᵣ required by the desired diffraction efficiencies at several wavelengths λᵢ.

4. A method according to claim 3, characterized in that the wavelength response of the desired diffraction efficiencies η_{d} are determined so as to substantially compensate the spectrum (5) of a light source in an optical system comprising the light source and the diffraction grating (1).

5. A method according to claim 1, characterized in that the method comprises the step of parameter optimizing wherein the dimensions of the pillars (2) and grooves (3) calculated on the basis of the effective refractive indices n_{eff} are used as a starting point for the optimization procedure.

6. A diffraction grating structure (1), the grating period (d) of the structure comprising at least two grating lines each consisting of a pair of adjacent pillars (2) and grooves (3), characterized in that the dimensions of the pillars (2) and grooves (3) are such that when calculating for each pillar, on the basis of the effective refractive index n_{eff} for the fundamental wave mode propagating along that pillar, the phase shift Φ experienced by light propagated through the grating structure, the differences in the calculated phase shifts between adjacent pillars correspond to the phase profile Φᵣ required by predetermined desired diffraction efficiencies η_{d} of the diffraction orders.

7. A diffraction grating structure (1) according to claim 6, characterized in that the predetermined desired diffraction efficiencies η_{d} are substantially constant in a wavelength range from λ₁ to λ₂, and the dimensions of the pillars (2) and grooves (3) are adjusted so as to produce the differences in the calculated phase shifts Φ between adjacent pillars (2) substantially constant in that wavelength range.

8. A diffraction grating structure (1) according to claim 7, characterized in that the wavelength λ₁ is at least 1.5 times, preferably at least 2 times as big as the wavelength λ₂.

9. A diffraction grating structure (1) according to claim 6, characterized in that the predetermined desired diffraction efficiencies η_{d} have a non-constant wavelength response, and the dimensions of the pillars (2) and grooves (3) are such that they produce said correspondence between the calculated phase shifts Φ and the phase profile Φᵣ required by the desired diffraction efficiencies at several wavelengths λᵢ.

10. A diffraction grating structure (1) according to claim 9, characterized in that the wavelength response of the predetermined desired diffraction efficiencies η_{d} substantially compensate the spectrum (5) of a light source in an optical system comprising the light source and the diffraction grating (1).

11. A diffraction grating structure (1) according to claim 6, characterized in that the grating period (d) of the diffraction grating structure (1) comprises at least two different groove depths.

12. A diffraction grating structure (1) according to claim 6, characterized in that the grating period (d) of the diffraction grating structure comprises at least three grating lines.

13. A diffraction grating structure (1) according to claim 6, characterized in that the grating structure (1) is of slanted type.
